(19) United States
(12) Patent Application Publication
(10) Pub. No.: US 2017/0261290 A1
(43) Pub. Date: Sep. 14, 2017

(54) Systems, Devices, and Methods for Wind Indication

(71) Applicants: David Kristopher Bonine, Grants Pass, OR (US); Randy Nelson Yow, LaPine, OR (US)

(72) Inventors: David Kristopher Bonine, Grants Pass, OR (US); Randy Nelson Yow, LaPine, OR (US)

(21) Appl. No.: 15/456,092

(22) Filed: Mar. 10, 2017

Related U.S. Application Data
(60) Provisional application No. 62/307,142, filed on Mar. 11, 2016.

(51) Int. Cl. F41G 3/08; G01P 5/00

(52) U.S. Cl. CPC F41G 3/08; G01P 5/001

(57) ABSTRACT

The disclosure generally relates to a wind indicating device. In various embodiments, the device can be used for wind detection and wind direction determination. The device can, in various embodiments, produce visible vapor and/or smoke. The visible smoke can interact with wind such that an operator can see which direction the wind is traveling and/or swirling. This can be beneficial for operators in the pursuit of game for hunting purposes, or in more general application in military actions.

### RELATED APPLICATION DATA

This patent is related to and claims priority benefit of U.S. Provisional Application No. 62/307,142 filed Mar. 11, 2016 and entitled “Systems, Devices, and Methods for Wind Indication.” The entire contents of these prior filed provisional applications are hereby incorporated herein by reference.

### FIELD OF THE DISCLOSURE

The disclosure generally relates to a wind indicating device.

### BACKGROUND

Firearm components and accessories may be attached to the muzzle end of the barrel of a firearm, such as a handgun, and/or bows, for example, bows used in hunting.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example wind indicating device in accordance with one or more embodiments of the disclosure.

FIG. 2 depicts an example wind string assembly in accordance with one or more embodiments of the disclosure.

### DETAILED DESCRIPTION

The disclosure generally relates to a wind indicating device. In various embodiments, the device can be used for wind detection and wind direction determination.

Disclosed herein are systems, methods, and devices directed to producing visible smoke; the visible smoke can interact with the wind such that the operator can see which direction the wind is traveling and/or swirling. This can, in various applications, aid an operator in the pursuit of game for hunting, or in more general application in military actions.

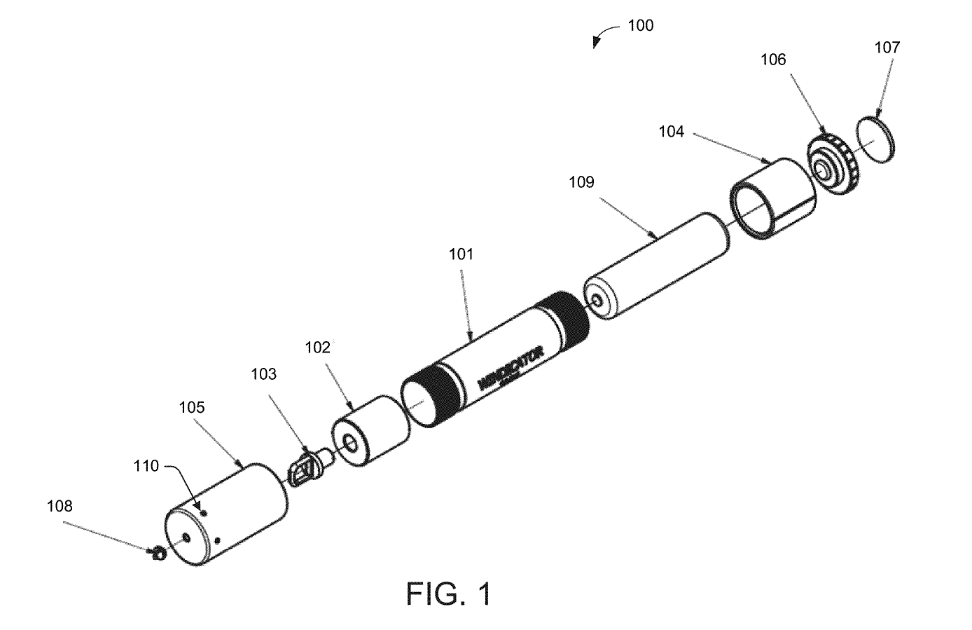

FIG. 1 shows an example wind indicating device 100. The device 110 can comprise a main body 101 comprising a tubular structure that can hold and integrate with the remaining parts of the device 100. The device 100 that can emit, and or produce a vapor from one or more ports 110 and/or one or more holes on one side of the device 100, for example, on the front side of the device. In some embodiments, the device 100 can be from approximately 2½″ long to approximately 4½″ long. Moreover a diameter associated with the device 100 can be as from approximately ¼″ to approximately ¾″. In various aspects, the size of the device 100 can depend on the use of that particular device 100.

The device can have a battery compartment (not shown) which attaches to a reservoir 102, and a coil 103. The coil 103 can have a small piece of cotton (not shown) attached to it to absorb glycol. The glycol can be stored in a detachable glycol reservoir (not shown). The glycol reservoir (not shown) can be interchangeable such that additional reservoirs may be swapped out for different scented glycol and or colored glycol. The glycol can wick into the cotton in the coil 103, and when the coil 103 is fired, the device 100 can heat the glycol and create visible smoke (not shown). The visible smoke can be exit out of one or more ports 110 one side of the device 100. This portion of the device 100 can be called the dispersion chamber 105.

The dispersion chamber 105 can have ports 110 in different locations depending on the use of the device. For example, if the device 100 is attached to a firearm or bow with the bow lying horizontally, the series of ports (for example, ports 110) can be on the front, bottom, and up half way on the sides to let the visible smoke out depending on angle at the time. The dispersion chamber 105 can be interchangeable with different styles and sizes of chambers for different mounting applications and or climate conditions.

In various embodiments, an operator can push a button 107 on the device 100, and thereby produce visible smoke, for example, to test wind conditions. Alternatively or additionally, an operator can adjust a constant power setting via a rotary switch 106 or momentary two way push button (not shown) with a power level display (not shown) on the device 100. In various embodiments, the device 100 can comprise a timer (not shown. The timer and/or the rotary switch can allow the operator to leave the device 100 on in order to emit continuous visible smoke for a period of time, for example, in order to perform a constant wind check. The device 100 can be used in many scenarios in the hunting, sporting and military fields, for example, to check the direction, and/or drift conditions of the wind.

The device 100 can have a universal mounting point (not shown). The universal mounting point can allow for the attachment of various mounting adapters. Example mounting adapters can include a “U” shaped firearm barrel clip, a Picatinny rail adapter, a key-mod adapter, a tripod adapter, and the like.

In various embodiments, an operator can reach out and turn the device 100 on, or off, can leave the unit on, or test wind with a momentary push button while in the off position.

In one embodiment, the device 100 can be affixed to a bow, for example, on front of the bow handle. In another embodiment, the device 100 can universally attach to the stabilizer of the bow. In yet other embodiments, stabilizers for bows can have the device 100 built into the stabilizers for ease of use.

In some embodiments the device 100 can be built to be standalone but have mounting capabilities. For example, the device 100 can kept in an operators pocket; alternatively, the device can hang from an operator's neck with a lanyard; the device 100 can then be attached to a firearm or bow with supplied attachments peripherals. In another embodiment, the device 100 can be built into the stocks of firearms and/or bows.

In one embodiment, the visible smoke may also have a scent produced by the device 100. In some situations, it may be desired that the visible smoke and/or scent be at a predetermined target location without the operator's presence. This may require a remote control (not shown) to operate the device 100 from a distance. The remote control can have a waterproof key fob format. The remote control can moreover have a display that corresponds to the settings and features of the device 100.

In one embodiment, the device 100 can have a small U-shaped loop ring 108 on a side of the device 100 (for example, the front of the device 100) to attach a wind string. The wind string can be used for wind detection, for example, when the device 100 is not being used to produce visible smoke.

In various embodiments, the device 100 can be made waterproof. Waterproofing can be accomplished through the use of O-rings and rubber gaskets (not shown) to seal the electronics and glycol reservoir from external moisture. In other embodiments, the device 100 can have waterproof rubber power control buttons.

The glycol can be used for the production of visible smoke. As mentioned, different types of scent can be added to the glycol. Non-limiting scent example can include: earth scents, tree scents, sage scents, grass type scents, game scents, elk urine scents, elk scents, deer urine scents, and the like. The visible smoke produced by the device can then be carried by the wind, leaving the desired scent. This can, for example, aid in masking human odor.

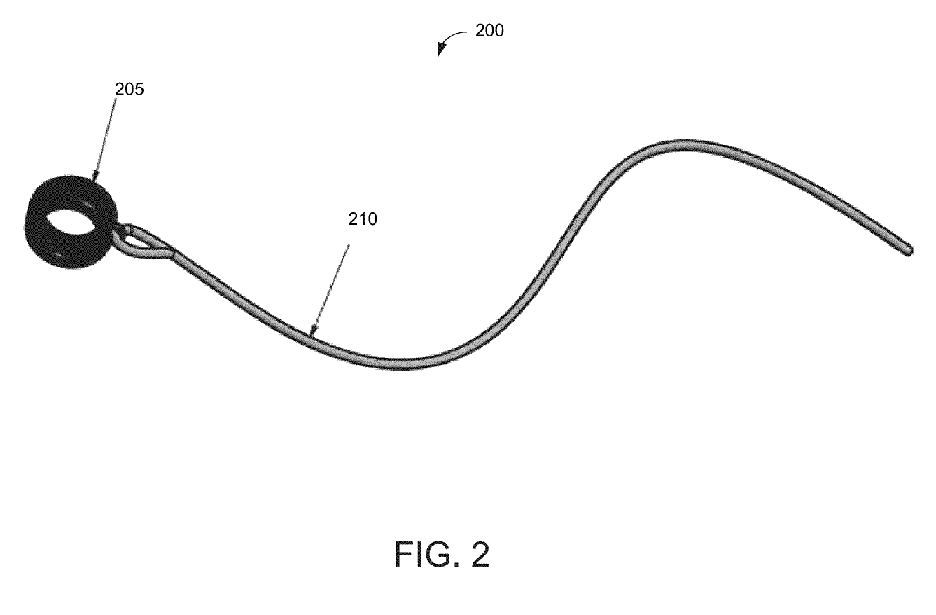

As shown in FIG. 2, the wind string assembly 200 can comprise a round, elastic (for example, made from rubber), expandable ring 205 with a small loop on it. An approximately 6″ to approximately 12″ piece of string 210 can be threaded through the ring. The string 210 can be made of polyester, nylon, wool, and or any material that can fuzz out, and dry quickly to catch the slightest movement, or drift of the wind. This string 210 can hang down from ring 205. In one embodiment, the string 210 can be pulled apart, fuzzed out, in very fine individual string like fuzz, so it can catch the slightest breath of air movement.

A small U-shaped loop (for example, loop 108 of FIG. 1) can be disposed on the device (for example, the device 100 of FIG. 1) for the wind string 210 to be attached. As such, wind can be detected without turning on or using the device for simple wind direction. These strings can be attached over the barrel of a firearm and/or bow stabilizer with the expandable elastic or rubber ring connector. In one embodiment, a Velcro, U-shaped plastic connectors for bows or firearms, and/or other attachment methods to attach the wind string 210 to many different combinations said bows and/or firearms.

In one embodiment, a cup-shaped cover (not shown) can be used to protect the string 210 during wet conditions to keep it dry. In another embodiment, the wind string 210 can comprise multiple string that can be pulled out as needed from the covered waterproof device.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A wind detecting device, comprising:
a reservoir for holding fluid;
a heating coil assembly;
a dispersion chamber; and
a power source;
wherein the reservoir transfers the fluid from the reservoir to the heating coil assembly; and
wherein the heating coil assembly uses electrical power provided by the power source to heat the fluid to produce vapor through one or more ports in the dispersion chamber.

2. The wind detecting device of claim 1, wherein the reservoir is a detachable reservoir.

3. The wind detecting device of claim 1, wherein the fluid further comprises glycol.

4. The wind detecting device of claim 3, wherein the glycol further comprises colored glycol.

5. The wind detecting device of claim 3, wherein the glycol further comprises a scented glycol.

6. The wind detecting device of claim 1, wherein the wind detecting device further comprises a timer.

7. The wind detecting device of claim 6, wherein the timer is set to maintain continuous vapor production for a pre-determined time.

8. The wind detecting device of claim 1, wherein the wind detecting device further comprises a universal mount for mounting the wind detecting device on a firearm or a bow.

9. The wind detecting device of claim 8, wherein the universal mount further comprises a U-shaped firearm barrel clip a Picatinny rail adapter, a key-mod adapter, or a tripod adapter.

10. The wind detecting device of claim 1, wherein the wind detecting device is built into a stabilizer of a bow.

11. The wind detecting device of claim 1, wherein the wind detecting device is built into the stock of a firearm.

12. The wind detecting device of claim 1, wherein the wind detecting device further comprises a remote control for remote operation of the wind detecting device.

13. The wind detecting device of claim of claim 12, wherein the remote control further comprises a waterproof remote control.

14. The wind detecting device of claim 1, wherein the wind detecting device further comprises a wind string.

15. The wind detecting device of claim 14, wherein the wind string further comprises polyester, nylon, or wool.
